(19) United States
(12) Patent Application Publication
(10) Pub. No.: US 2009/0286134 A1
(43) Pub. Date: Nov. 19, 2009

(54) END PLATE FOR FUEL CELL STACK AND METHOD FOR MANUFACTURING THE SAME

(75) Inventors: Sae Hoon Kim, Gyeonggi-do (KR); Sung Ho Lee, Gyeonggi-do (KR); Jung Do Suh, Seoul (KR); Byung Ki Ahn, Gyeonggi-do (KR); Tae Won Lim, Seoul (KR); Dai Gil Lee, Daejeon (KR); Seong Su Kim, Gyeongsangnam-do (KR); Ha Na Yu, Gyeongsangbuk-do (KR); In Uk Hwang, Gyeonggi-do (KR)

Correspondence Address: EDWARDS ANGELL PALMER & DODGE LLP, P.O. BOX 55874, BOSTON, MA, 02205, US

(73) Assignees: HYUNDAI MOTOR COMPANY, Seoul (KR); KOREA ADVANCED INSTITUTE OF SCIENCE AND TECHNOLOGY, Daejeon (KR)

(21) Appl. No.: 12/276,953

(22) Filed: Nov. 24, 2008

(30) Foreign Application Priority Data
May 13, 2008 (KR) 10-2008-0043731

(51) Int. Cl. H01M 2/00

(52) U.S. Cl. 429/34; 29/623.4

(57) ABSTRACT

The present invention provides an end plate for fuel cell stack and a method for manufacturing an end plate, which can increase flexural rigidity per weight, and improve strain at break, and reduce heat transmission by applying hybrid core element having honeycomb and form structures to an end plate having sandwich structure combined to both end portions of a fuel cell stack.

### CROSS-REFERENCE TO RELATED APPLICATION

This application claims under 35 U.S.C. §119(a) the benefit of Korean Patent Application No. 10-2008-0043731 filed May 13, 2008, the entire contents of which are incorporated herein by reference.

### BACKGROUND

(a) Technical Field

The present invention relates to an end plate for a fuel cell stack and a method of manufacturing the same. More particularly, the present invention relates to an end plate for a fuel cell stack and a method of manufacturing the same, wherein said end plate and manufacturing method can increase flexural rigidity per weight, strain at break, and reduce heat transmission by employing a sandwich structured end plate having a hybrid core combined with honeycomb and foam.

(b) Background Art

A polymer electrolyte membrane fuel cell or a proton exchange membrane fuel cell (“PEMFC”) generates electricity by electrochemically reacting hydrogen and oxygen. The PEMFC has better efficiency, greater current and output density, smaller starting time and faster response to load changes than other types of fuel cells.

A membrane-electrode assembly (“MEA”) is disposed at the most inner part of a fuel cell unit. The MEA conventionally includes a solid polymer membrane layer, through which hydrogen protons pass, and catalyst layers coated on both surfaces of the membrane layer to react hydrogen and oxygen. The catalyst layer includes a cathode and an anode.

Preferably, a gas diffusion layer (“GDL”) and a gasket are disposed at the outermost part of the membrane where the cathode and the anode are disposed. A separator having a flow field is disposed ton the outside of the GDL to provide fuel and exhaust water. An end plate is combined at the most outer part to support the above elements.

Thus, at the anode of the fuel cell, a hydrogen ion and an electron are generated by oxidation of the hydrogen. The generated hydrogen ion and the electron are moved to the cathode through the membrane layer and the separator, respectively.

Water is generated at the cathode by the electrochemical reaction of the hydrogen ion and the electron, which are moved from the anode, and oxygen which is contained in the air. Electrical energy is generated from such flow of the electron.

In the fuel cell stack, the end plate serves to support components while maintaining uniform surface pressure exerted on each component. . . . In addition, the end plate serves to minimize heat loss and stabilize temperature in the fuel cell stack in a short period, so that the fuel cell has considerable cold startability.

Maintaining a uniform surface pressure to each component in the stack is important to prevent leakage of liquid inside the stack and also to prevent increase of electrical contact resistance between cells.

In addition, a smaller thermal conductivity of the end plate is advantageous in preventing heat loss from the stack, and maintaining a constant temperature of the stack.

A conventional end plate includes stainless-steel to sustain the uniform surface pressure. However, as the weight of an end plate made of stainless steel exceeds 7 to 8 kilograms, handling the end plate becomes difficult. Further, since the metal is not suitable for insulation of heat, the cold start property deteriorates.

Thus, the properties of the end plate that make contact with the separator of the fuel cell stack, have been investigated concerning the materials, designs and manufacturing processes for making an end plate that is suitably lighter and has proper flexural rigidity and suitably lower thermal conductivity in order to improve cold start.

Accordingly, an end plate having a sandwich structure has been described, and a method for manufacturing the core element of the sandwich-structured end plate includes suitably expanding foams into a honeycomb member to resist compression and shock.

The above information disclosed in this Background section is only for enhancement of understanding of the background of the invention and therefore it may contain information that does not form the prior art that is already known in this country to a person of ordinary skill in the art.

### SUMMARY

In one aspect, the present invention is directed to an end plate for a fuel cell stack comprising: a core element with a honeycomb comprising one or more cells filled with foam; and a plate element attached to the core element while covering the same, wherein the foam filled in the cell of the honeycomb is an expanded foam or a closed cell foam.

In a preferred embodiment, the foam is further furnished with thermal insulating means.

In another preferred embodiment, the thermal insulating means comprises thermoplastic resin which is suitably coated and cured at an outer surface of the honeycomb or the foam.

In still another preferred embodiment, the thermal insulating means comprises carbon dioxide that is preferably injected into the foam while foaming the foam within each cell of the honeycomb.

In still another preferred embodiment, the cells of the honeycomb are filled with an upper closed cell foam and a lower closed cell foam, wherein the thermal insulating means preferably comprises a carbon dioxide gas layer or a aerogel sheet, the thermal insulating means being interposed between the upper closed cell foam and the lower closed cell foam.

In still another preferred embodiment, the thermal insulating means includes a plurality of porous holes suitably formed at walls of each cell of the honeycomb, a vacuum providing mean provided to the filled foam in the honeycomb through the holes and a thermoplastic material suitably melted by heating to be filled into the holes.

In another aspect, the present invention provides a method of manufacturing an end plate for a fuel cell stack, comprising steps of: mounting honeycomb within a box type element with a substantially box shape having an upper opening; disposing expanded foam material on the honeycomb; and forcibly inserting the expanded foam material into each cell of the honeycomb.

In a preferred embodiment, the method further comprises steps of coating resin to the honeycomb or the foam and suitably curing the resin.

In still another aspect, the present invention provides a method of manufacturing an end plate for a fuel cell stack, comprising steps of: placing a foam material in each cell of a honeycomb; expanding the foam material such that each cell is filled with the expanded foam; and injecting carbon dioxide into the foam material while the foam material is expanded.

In yet another aspect, the present invention provides a method of manufacturing an end plate for a fuel cell stack, comprising steps of: mounting honeycomb within a box type element with a substantially box shape having an upper opening; forcibly inserting a lower closed cell foam into each cell of the honeycomb; providing an thermal insulating layer on the lower closed cell foam, the insulating layer preferably being carbon dioxide gas layer or aerogel sheet; and forcibly inserting a upper closed cell foam into each cell of the honeycomb.

In still yet another aspect, the present invention provides a method of manufacturing an end plate for a fuel cell stack, comprising steps of: preparing a honeycomb having a plurality of porous holes formed at walls of each cell thereof, the honeycomb including thermoplastic material disposed at walls of cells, which are positioned at corners; disposing expanded foam on the honeycomb; forming a core element by forcibly inserting the expanded foam material into each cell of the honeycomb; adhering plate elements to an upper and lower surfaces of the core element; and vacuum packing the core element to suitably generate vacuum inside the foam of the honeycomb.

In a preferred embodiment, the method further comprises a step of heating the vacuum packed core element to suitably melt the thermoplastic material and to fill up the porous holes of the honeycomb.

According to the present invention, a core element for an end plate is easily manufactured by suitably pressing constantly deposited honeycomb and foam to insert the foam into the honeycomb, or suitably expanding the foam in the honeycomb. The end plate is preferably applied as a sandwich hybrid material, so that weight is lightened and proper flexural rigidity is obtained when combined to the fuel cell stack. Thus, uniform surface pressure to the stack is maintained.

Moreover, additional thermal insulating means is applied to the honeycomb or the foam, so that thermal insulation is improved, thereby, the fuel cell stack is operated well even when cold start. Thus, the efficiency of the fuel cell is suitably improved.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated by the accompanying drawings which are given hereinbelow by way of illustration only, and thus are not limitative of the present invention, and wherein:

FIGS. 1A and 1B are vertical cross-sectional view and horizontal cross-sectional view illustrating an end plate for fuel cell stack of the present invention;

FIG. 2 is a schematic diagram showing a method for manufacturing an end plate in accordance with a first embodiment of the present invention;

FIG. 3 is a schematic diagram showing a method for manufacturing an end plate in accordance with a second embodiment of the present invention;

FIG. 4 is a schematic diagram showing a method for manufacturing an end plate in accordance with a third embodiment of the present invention;

FIG. 5 is a schematic diagram showing a method for manufacturing an end plate in accordance with a fourth embodiment of the present invention; and

FIGS. 6 and 7 are graphs presenting physical properties of a honeycomb-foam core element.

Reference numerals set forth in the Drawings includes reference to the following elements as further discussed below:

| | |
|---|---|
| 10: plate element | 12: box type element |
| 20: core element | |
| 21: honeycomb | 22: foam |
| 23: cell space | |
| 24: thermal insulation layer | |
| (carbon dioxide layer or | |
| aerogel sheet) | |
| 26: hole | 28: thermoplastic material |
| 30: vacuum bag | 40: adhesive agent |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

As described herein, the present invention includes an end plate for a fuel cell stack comprising a core element with a honeycomb comprising one or more cells filled with foam; and a plate element attached to the core element. In preferred embodiments, the plate element is attached to the core element, while covering the same. In further preferred embodiments, the foam filled in the cell of the honeycomb is an expanded foam or a closed cell foam. In another preferred embodiment, the foam is further furnished with thermal insulating means.

The invention also includes a method of manufacturing an end plate for a fuel cell stack, comprising the steps of forming a core element having a honeycomb filled with foam; and adhering a plate element to the core element so as to enclose entire or partial surface of the core element.

In a preferred embodiment of the method, forming a core element having a honeycomb filled with foam further comprises disposing expanded foam material on a honeycomb and forcibly inserting the foaming material into each cell of the honeycomb, or expanding foam material within each cell of the honeycomb.

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

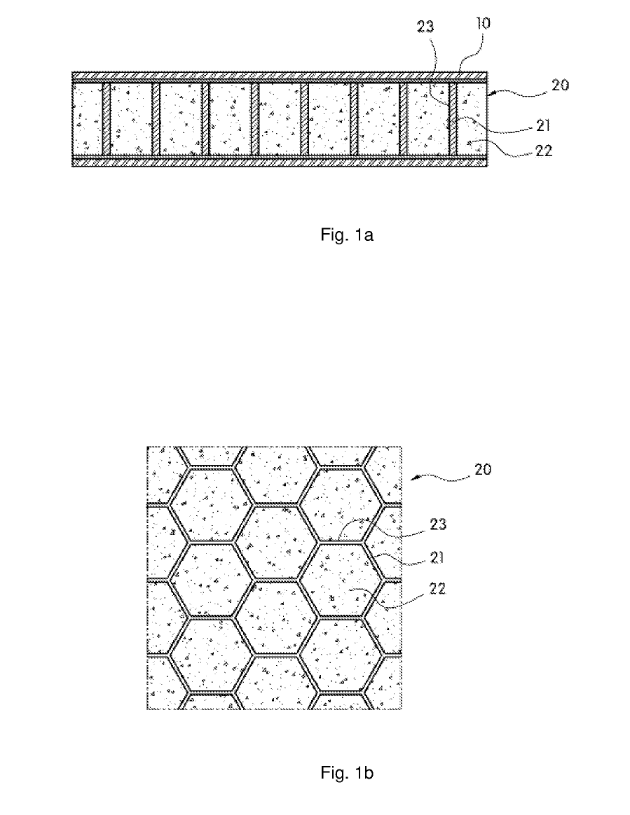

FIGS. 1A and 1B are exemplary vertical cross-sectional views and horizontal cross-sectional views illustrating an end plate for a fuel cell stack of the present invention.

In certain embodiments, the end plate of the present invention is preferably formed as a sandwich structure having a core element 20 and plate elements 10 which are suitably disposed at upper and lower parts of the core element 20. The core element 20 is preferably composed of a honeycomb 21 and a foam 22.

In certain embodiments, the plate element 10 of the end plate may preferably include metallic material, composite material with filler, fiber reinforced composite material, polymer material, etc.

In other embodiments, the core element 20 preferably includes the honeycomb 21 and the foam 22, and the honeycomb 21 may suitably include, but is not limited to, aluminum honeycomb, glass fiber honeycomb, various plastic honeycombs and so on. The foam 22 may preferably include low thermal conductivity material such as, but not limited to, polyvinyl chloride (“PVC”), polyethylene terephthalate (“PET”), poly styrene (“PS”), poly urethane (“PU”) and so on.

Preferably, the plate element 10 and the core element 20 are suitably adhered by an adhesive agent 40 which is glued on a boundary surface between the plate element 10 and the core element 20.

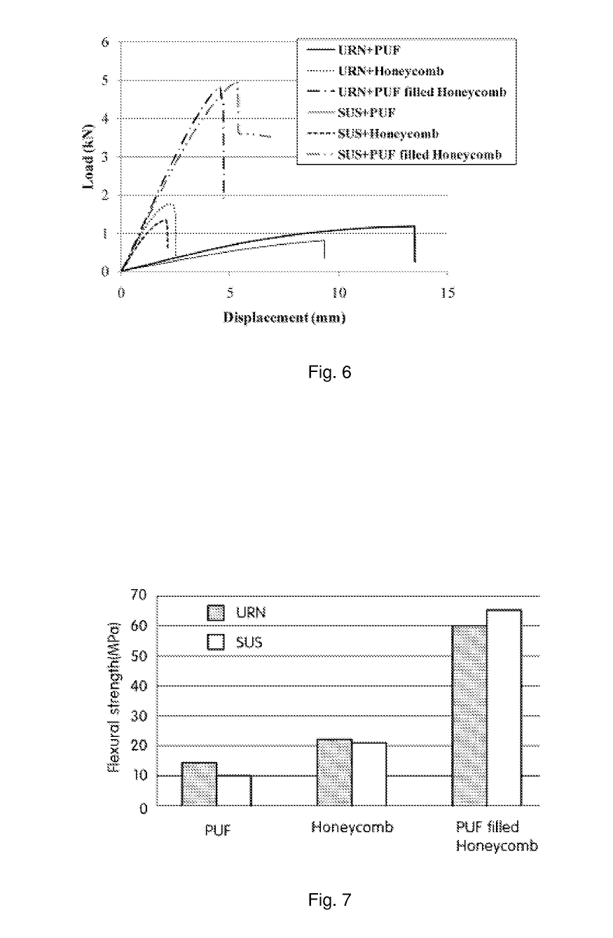

As illustrated in FIGS. 6 and 7, an end plate consisting of only honeycomb shows superiority in flexural rigidity, and on the other hand an end plate consisting of only foam material shows superiority in strain at break. Thus, the end plate according to the present invention, which combines the honeycomb and the foam material, has well-balanced physical properties of flexural rigidity and strain at break.

In a method of manufacturing an end plate in accordance with a first preferred embodiment of the present invention, a core element is suitably manufactured by a press-insert method.

In one embodiment, the end plate with a sandwich structure, which preferably includes the core element and the plate element adhered to both surfaces of the core element, is suitably manufactured as the following method.

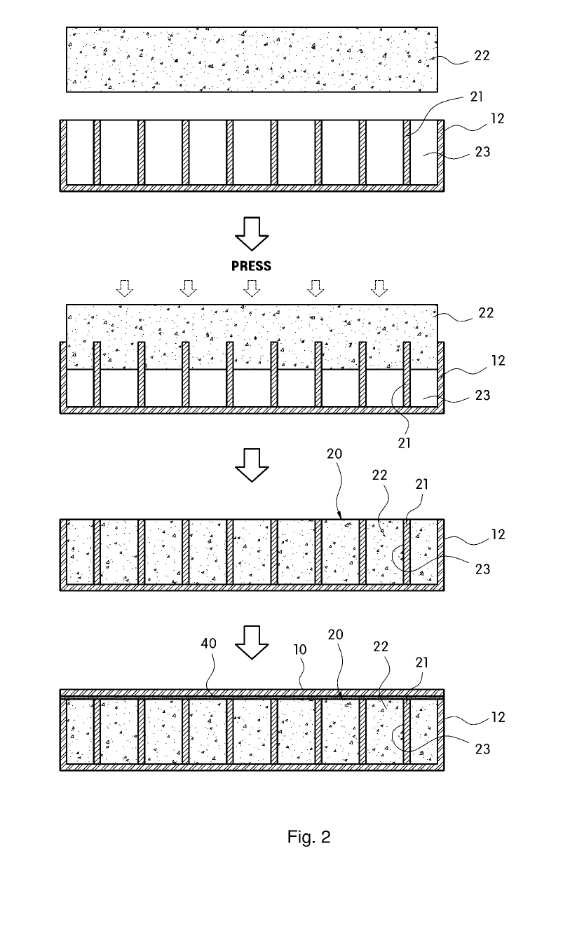

FIG. 2 is a schematic diagram showing an exemplary method for manufacturing an end plate in accordance with a first embodiment of the present invention.

In exemplary embodiments, the core element 20 preferably has a combination structure of a honeycomb 21 and a foam 22. The honeycomb 21 is preferably formed as a plurality of cell structures. In certain embodiments, the cell structures preferably include a thin plate, and are extended in a substantially vertical direction as a substantially hexagonal shape. A honeycomb structure has considerably high resistance against compression and the foam is a suitable material having a considerably low density. Preferably, by using such characteristics of the honeycomb and the foam, the foam may be easily inserted into each cell of the honeycomb. In particular embodiments, the foam material can be easily inserted into each cell space 23 of the honeycomb 21 by suitably pressing the foam 22 material using a press (not shown) after suitably disposing the expanded foam 22 material with low density of about 40 to 50 kg/m³ on the honeycomb 21 that is seated within a box type element 12 having an upper opening.

In preferred embodiments, the core element having a sandwich structure combined with the honeycomb and the foam may be manufactured, preferably by pressing the foam material after manufacturing separately and suitably depositing the honeycomb 21 and the foam 22.

In exemplary embodiments, the plate element 10 is preferably adhered by the adhesive agent 40 on the upper surface of the core element 20, at which the foam 22 may be suitably inserted into each cell space 23. The end plate is formed as the entire core element 20 is suitably surrounded by the plate element 10 and the box type element 12. The end plate is preferably formed with the honeycomb 21 and the foam 22, so that the weight is small and has thermal conductivity. Thus, a cold start is improved by the end plate, and the end plate has suitable flexural rigidity.

In preferred embodiments, in order to increase rigidity in a plate direction as well as in a thickness direction of the core element 20, the foam 22 or the honeycomb 21 material is preferably dipped in resin, and the foam 22 and honeycomb 21 are preferably inserted into each cell space 23, for example, by pressing as described above, and the resin is suitably cured. Thus, in further embodiments, the core element having both good points of the honeycomb and the foam and increasing the rigidity in the plate direction may be manufactured.

According to preferred embodiments, the resin coated at outer surfaces of the foam the honeycomb preferably functions as a lubricant, which helps the foam 22 to insert into each cell space of the honeycomb 21. In other further embodiments, the resin preferably functions as an adhesive agent to adhere the honeycomb and the foam firmly, and the resin functions as a thermal insulator.

In an exemplary method for manufacturing an end plate in accordance with a second preferred embodiment of the present invention, a foam is inserted in each cell of a honeycomb, and is suitably expanded.

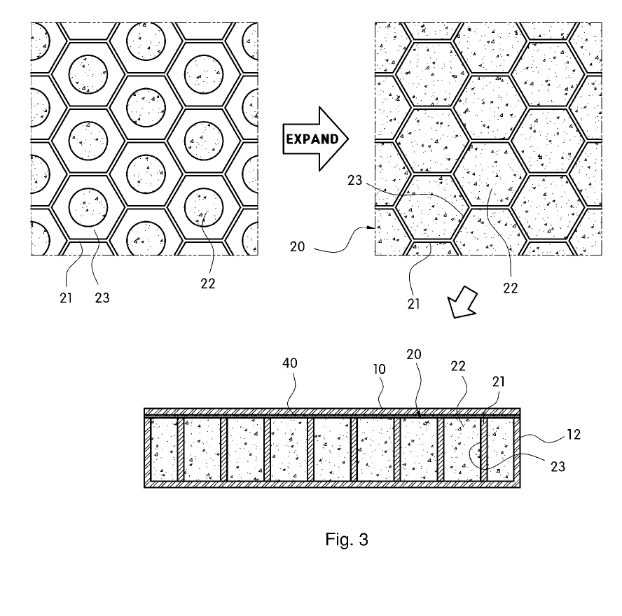

FIG. 3 is a schematic diagram showing an exemplary method for manufacturing an end plate in accordance with a second embodiment of the present invention.

As illustrated in FIG. 3, the foam 22 is suitably inserted into each cell space 23 of the honeycomb 21, and the foam material is suitably expanded by an expanding device (not shown). The core element 20, at which the foam 22 is expanded and filled into each cell space 23 of the honeycomb 21, is manufactured.

In order to lower thermal conductivity of the end plate, according to further embodiments, an additional carbon dioxide layer is formed by preferably inserting carbon dioxide into the foam 22 material when expanding the foam 22 material or preferably inserting carbon dioxide, which is thermal insulator, into surfaces of the foam after expanding.

The initial thermal insulation performance is suitably maintained when carbon dioxide is not escaped from the foam at both cases.

Preferably, walls of the core element 20 are partitions of the cell space of the honeycomb, so that carbon dioxide is suitably blocked from leaking gas. However, in further preferred embodiments, the upper and lower walls of the core element 20 are opened. Thus, the plate element 10 with box shape as illustrated in exemplary FIG. 3 is adhered at entire surfaces of the core element 20 to be sealed, so that leaking gas of the carbon dioxide thermal insulation layer to the air is suitably prevented.

The carbon oxide has suitably low thermal conductivity as presented in table 1, so that thermal insulation is improved.

TABLE 1

| | Thermal conductivity (W/mK) |
|---|---|
| SUS | 16.3 |
| Polyurethane Foam | 0.09 |
| carbon dioxide | 0.0144 (@ −20° C.) |
| Air | 0.0235 (@ −20° C.) |
| Aerogel | 0.01 |

In an exemplary method for manufacturing an end plate in accordance with a third preferred embodiment of the present invention, the same method as the first embodiment is proceeded, but dry ice or aerogel sheet is preferably used to improve thermal insulation effect.

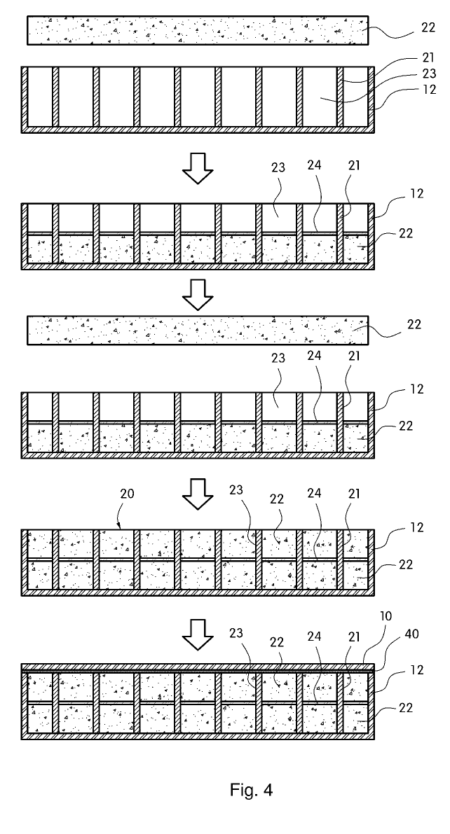

FIG. 4 is a schematic diagram showing a preferred method for manufacturing an end plate in accordance with a third embodiment of the present invention.

In one embodiment, the honeycomb 21 is suitably mounted in the box type element 12 with a substantially box shape having an upper opening, and the foam 22 preferably including high density closed cell on the honey comb 21. Preferably, the foam 22 having the closed cell is inserted easily into each cell space of the honeycomb 21 by pressing the foam 22.

According to further embodiments, the foam 22 having the closed cell is suitably filled into each cell space of the honeycomb 21. Preferably, dry ice is inserted on the foam 22 as thermal insulation layer to generate carbon dioxide layer, or the foam 22 having the closed cell is suitably pressed and inserted on an aerogel sheet after the aerogel sheet is inserted on the foam 22.

Preferably, the aerogel sheet has low thermal conductivity as presented in table 1, so that thermal insulation is improved.

Preferably, the plate element 10 is adhered with adhesive agent 40 and suitably sealed to the entire surfaces of the core element 20, so that gas of the carbon dioxide layer is prevented from leaking to the air.

In an exemplary method for manufacturing an end plate in accordance with a fourth preferred embodiment of the present invention, the same method as the first embodiment is proceeded, but the thermal conductivity of the end plate is suitably lowered by using vacuum.

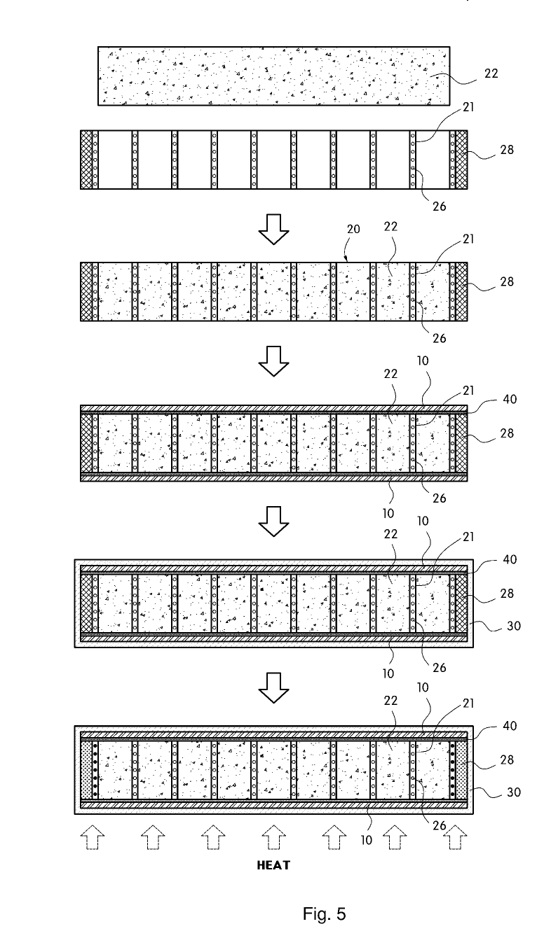

FIG. 5 is a schematic diagram showing a preferred method for manufacturing an end plate in accordance with a fourth embodiment of the present invention.

Preferably, about 40 to 50 kg/m³ of the expanded foam 22 material with low density is suitably disposed on the honeycomb 21, and the foam 22 material is pressed by the press. Accordingly, the core element 20, at which the foam 22 material is easily inserted into each cell space of the honeycomb 21, is manufactured.

In further embodiments, a plurality of porous holes 26 is suitably formed at walls of the cell space of the honeycomb 21, and preferably thermoplastic material 28 is suitably inserted at corner part of the cell walls of the honeycomb.

In exemplary embodiments, after the plate element 10 is adhered with adhesive agent 40 to the entire surfaces of the core element 20, and in further embodiments the inside is vacuumed by packing with a vacuum bag 30. Accordingly, the foam in the core element 20 is suitably vacuumed through the porous holes 26 of the honey comb 21.

In other exemplary embodiments, in order to suitably maintain vacuum state, the vacuum packed end plate is preferably heated, thereby, the thermoplastic material 28 is melted and fills the porous holes 26 of the honeycomb at the corner. Thus, the vacuum state in the core element is suitably maintained, and the thermal insulation effect is obtained by the vacuum state.

As described the above, the end plate of the present invention preferably applies light foam filled honeycomb as an exemplary core element, and can include various suitable thermal insulating means. Accordingly, the end plate as described herein is lighter and has higher thermal resistance to provide an improved cold start. Moreover, the end plate as described by the invention has suitable rigidity so as to provide uniform stack surface pressure.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An end plate for a fuel cell stack comprising:
a core element with a honeycomb comprising one or more cells filled with foam; and
a plate element attached to the core element while covering the same,
wherein the foam filled in the cell of the honeycomb is an expanded foam or a closed cell foam.

2. The end plate for a fuel cell stack of claim 1, wherein the foam is further furnished with thermal insulating means.

3. The end plate of claim 2, wherein the thermal insulating means comprises thermoplastic resin which is coated and cured at an outer surface of the honeycomb or the foam.

4. The end plate of claim 2, wherein the thermal insulating means comprises carbon dioxide that is injected into the foam while foaming the foam within each cell of the honeycomb.

5. The end plate of claim 2, wherein the cells of the honeycomb are filled with an upper closed cell foam and a lower closed cell foam, and wherein the thermal insulating means comprises a carbon dioxide gas layer or a aerogel sheet, the thermal insulating means being interposed between the upper closed cell foam and the lower closed cell foam.

6. The end plate of claim 2, wherein the thermal insulating means comprises a plurality of porous holes formed at walls of each cell of the honeycomb; a vacuum providing mean provided to the filled foam in the honeycomb through the holes; and a thermoplastic material melted by heating to be filled into the holes.

7. A method of manufacturing an end plate for a fuel cell stack, comprising steps of: mounting honeycomb within a box type element with a substantially box shape having an upper opening; disposing expanded foam material on the honeycomb; and forcibly inserting the expanded foam material into each cell of the honeycomb.

8. The method for manufacturing the end plate of claim 7, further comprising steps of coating resin to the honeycomb or the foam and curing the resin.

9. A method of manufacturing an end plate for a fuel cell stack, comprising steps of: placing a foam material in each cell of a honeycomb; expanding the foam material such that each cell is filled with the expanded foam; and injecting carbon dioxide into the foam material while the foam material is expanded.

10. A method of manufacturing an end plate for a fuel cell stack, comprising steps of: mounting honeycomb within a box type element with a substantially box shape having an upper opening; forcibly inserting a lower closed cell foam into each cell of the honeycomb; providing an thermal insulating layer on the lower closed cell foam, the insulating layer being carbon dioxide gas layer or aerogel sheet; and forcibly inserting a upper closed cell foam into each cell of the honeycomb.

11. a method of manufacturing an end plate for a fuel cell stack, comprising steps of: preparing a honeycomb having a plurality of porous holes formed at walls of each cell thereof, the honeycomb including thermoplastic material disposed at walls of cells, which are positioned at corners; disposing expanded foam on the honeycomb; forming a core element by forcibly inserting the expanded foam material into each cell of the honeycomb; adhering plate elements to an upper and lower surfaces of the core element; and vacuum packing the core element to generate vacuum inside the foam of the honeycomb.

12. The method of manufacturing the end plate of claim 11, further comprising a step of heating the vacuum packed core element to melt the thermoplastic material and to fill up the porous holes of the honeycomb.

13. A method of manufacturing an end plate for a fuel cell stack, comprising the steps of: forming a core element having a honeycomb filled with foam; and
adhering a plate element to the core element so as to enclose entire or partial surface of the core element.

14. The method of manufacturing an end plate for a fuel stack of claim 13, wherein forming a core element having a honeycomb filled with foam further comprises disposing expanded foam material on a honeycomb and forcibly inserting the foaming material into each cell of the honeycomb, or expanding foam material within each cell of the honeycomb.
